(19) United States
(12) Patent Application Publication
(10) Pub. No.: US 2007/0232097 A1
(43) Pub. Date: Oct. 4, 2007

(54) Fixing system for electrical connectors

(75) Inventor: Ercole Crippa, Lecco (IT)

Correspondence Address: HEDMAN & COSTIGAN P.C., 1185 AVENUE OF THE AMERICAS, NEW YORK, NY, 10036, US

(73) Assignee: STELVIO S.p.A.

(21) Appl. No.: 11/729,084

(22) Filed: Mar. 27, 2007

(30) Foreign Application Priority Data
Mar. 30, 2006 (IT) MI2006A 000607

(51) Int. Cl. H01R 13/648

(52) U.S. Cl. 439/108

(57) ABSTRACT

There is described a fixing system for electrical connectors of the type comprising at least one male element (10) and at least one corresponding female element (12) suitable for being reciprocally connected for making an electrical connection. On the outer sheath of one of the two elements (10) or (12) there are provided one or more appendages (24) adapted for the insertion of at least one threaded fixing element (26), whereas on the outer sheath of the opposite element there are provided one or more holes (28) adapted for the introduction of the stem of each fixing element (26). The threaded portion of each fixing element (26) engages with at least one plate (30) of varied shape, provided with a substantially central threaded hole (32) that arranges in coaxial position relative to each hole (28) when the plate (30) is mounted in rotation-prevented operating position.

The present invention relates to a fixing system for electrical connectors intended in particular for the use on printed circuits.

As known, connectors are devices that connect multiple electric or electronic circuits and/or portions of a same circuit. Generally, a connector consists of a “male” element or plug, provided with a plurality of pins, each transmitting an electrical signal, and a “female” element or tap, which exhibits a number of inputs suitable for seating the pins of the male element for correct signal transmission. Connectors of this type, connected to suitable cables through built-in terminals, are widely used in the field of electronics, for example for transferring data in the form of electrical signals between printed circuits.

To prevent the accidental disconnection of the male and female elements of the connection device, mechanical snap-fixing systems have long been used, normally consisting of one or more teeth, made in a single piece with the outer enclosure of insulating plastic material of one of the two connector elements, which engage into corresponding projections obtained on the sheath of the opposite element, once the connection of such elements has been made. However, a system of this kind is unreliable in particularly burdensome operating conditions of the connector, since a possible movement of the parts and/or the vibrations induced from the exterior may lead to the release of the components of the snap system, with consequent disconnection between the male and female elements and relevant interruption in the transfer of signals. Moreover, plastic teeth may be subject to breakage in the event of repeated handling of the connector, sometimes making it necessary to replace one or both coupling elements.

The need of imparting higher reliability to the connection between male and female elements for preventing the uncontrolled disconnection of the two parts during the end use, both in normal conditions (of static stability of male and female elements of the components connected thereto, such as cables and printed circuit) and in more burdensome conditions (movement/vibrations of the parts individually up to all parts simultaneously), has therefore led to the need of adding outer appendages to each of these two elements that respectively receive a screw, inserted for example on the female element, and a threaded pin, correspondingly inserted in the male element. The coupling action (screwing) between the screw and the threaded pin is capable of meeting heavier technical requirements and this fixing system can be used both in conjunction with the snap system and in replacement of the same.

The solution currently used by the manufacturers for fixing male-female connection devices, which is based on the use of a screw and turned pin requires making the pin, to be inserted in the male element, with a cylindrical shape having outer profile shaped with different roughness. However, such solution hardly ensures suitable mechanical seal of the pin itself in its plastic seat subsequent to the screwing action of the screw placed in the female element. The consequent rotation of the pin it its seat in fact implies the possible escape of the same in the direction of the axis of rotation of the screw and the failed seal of the two male and female elements.

Techniques for the ultrasound welding or hot coupling of the pins into their plastic seat have therefore been introduced for reducing the possibility of rotation and axial movement, but such techniques are not completely reliable and above all, expensive, since the number of equipment to be used and managed during the production process of the connector increases.

The object of the present invention therefore is to provide a fixing system for electrical connectors, in particular but not exclusively intended to be used on printed circuits, capable of ensuring optimum mechanical seal between the male and female elements irrespective of the conditions of use of the connector.

Another object of the present invention is to provide a fixing system for electrical connectors which should not require the performance of additional processes on the connector elements to increase the connection reliability.

Yet another object of the present invention is to provide a fixing system for electrical connectors which should be simple and inexpensive to make using the common manufacturing methods envisaged for this type of devices.

These objects according to the present invention are achieved by making a fixing system for electrical connectors as described in claim 1.

Further features of the invention are described in the following claims.

The features and the advantages of a fixing system for electrical connectors according to the present invention will appear more clearly from the following description, made by way of an indicative non-limiting example with reference to a particular example of embodiment illustrated in the annexed schematic drawings, wherein:

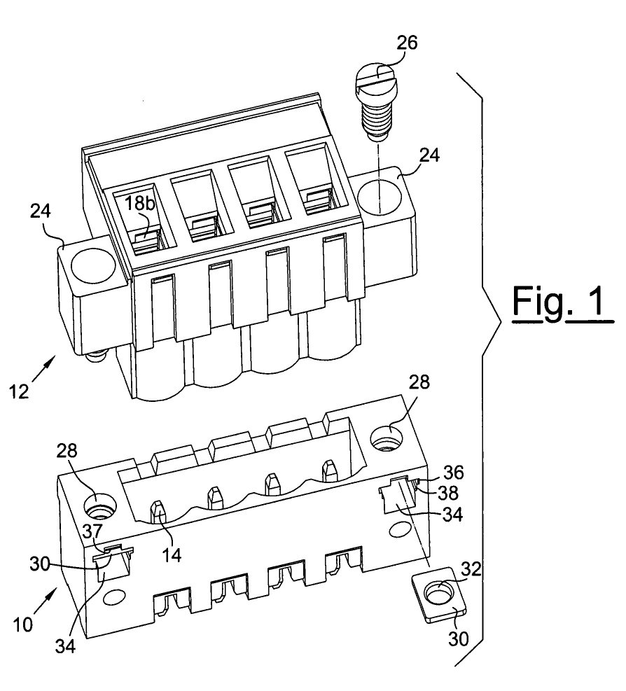

FIG. 1 is a perspective view of the two elements, male and female, of a connector provided with the fixing system according to the invention with one exploded plate and the other mounted;

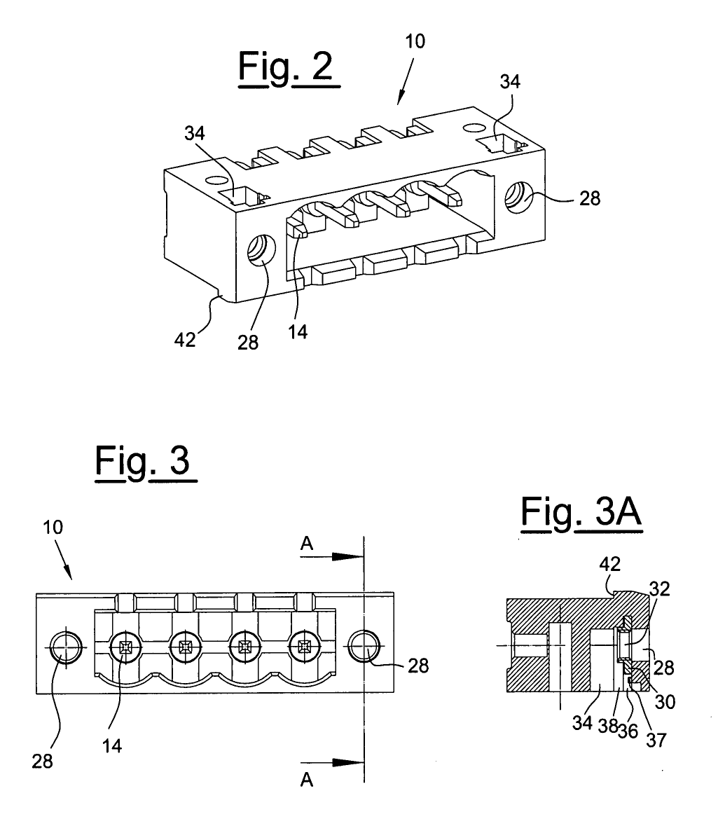

FIG. 2 is a perspective view of the male element of the connector of FIG. 1;

FIG. 3 is a plan view of the male element of the connector of FIG. 1;

FIG. 3A is a section view obtained along line A-A in FIG. 3;

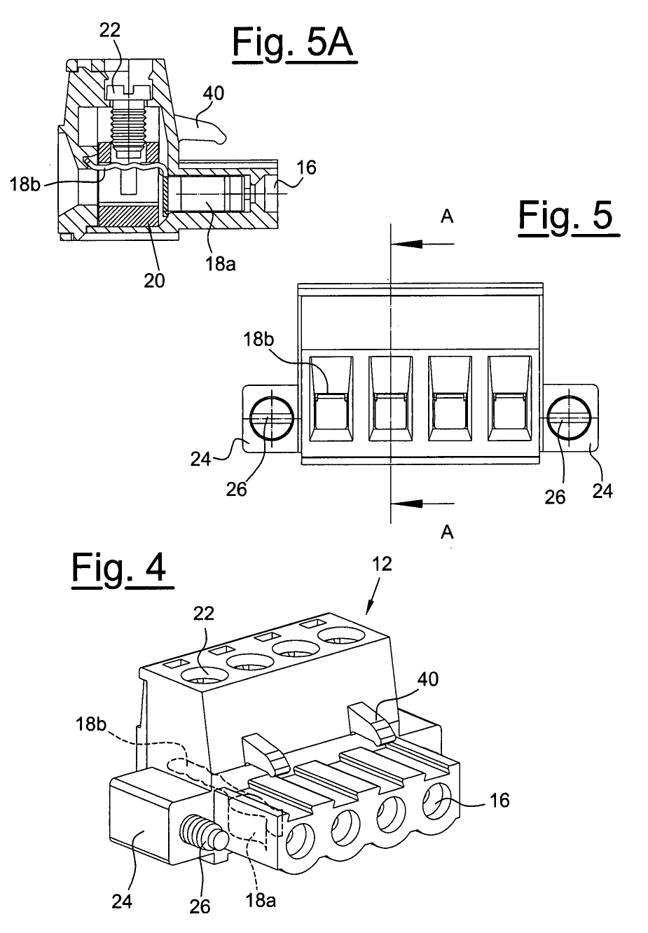

FIG. 4 is a perspective view of the female element of the connector of FIG. 1, wherein a female contact is shown by a dashed line;

FIG. 5 is a plan view of the female element of the connector of FIG. 1; and

FIG. 5A is a section view obtained along line A-A in FIG. 5.

With reference to the figures, there is shown a connector for electrical and electronic circuits consisting of a male element 10 and a corresponding female element 12 adapted for being reciprocally connected. In the particular example of embodiment shown, the male element 10 is provided with four pins 14 made of conductive material that insert into special holes 16 (visible in FIG. 4) obtained on the female element 12. Inside each hole 16 there is therefore provided a female contact 18a, comprising two tongues (FIGS. 4 and 5a), which extends in a shaped plate 18b, made of conductive material, intended to contact pins 14 once elements 10 and 12 of the connector have been correctly connected.

On one or both elements 10 and 12, there may be provided a series of terminals 20 with hollow nut, provided with relevant screws 22, within which the shaped plate extends 18b, so as to be electrically connected to pins 14 for connecting electrical cables (not shown) to the connector. In the example shown, the terminals are obtained on the female element 12 only.

To safely fix elements 10 and 12 of the connector to each other, once they have been correctly connected, on the outer sheath of plastic material of one of the two elements (the female element 12 in the example shown) there are provided one or more appendages 24 adapted for the insertion of at least one screw 26 or a similar threaded fixing element. Accordingly, corresponding holes 28 are provided on the outer sheath of the opposite element, in this case the male element 10, wherein the stem of each screw 26 is introduced during the assembly.

Advantageously, the threaded portion of each screw 26 engages with a plate 30 with sharp edges, preferably of metal, provided with a substantially central threaded hole 32 that arranges in coaxial position relative to hole 28 when said plate 30 is mounted in operating position. According to preferred embodiments, plate 30 is made with rectangular or square shape to better adhere to the walls of its insertion portion or to be better placeable, not turnable, in operating position, as shall be better described hereinafter. In the embodiment shown, the depth of the plate portion wherein threaded hole 32 is provided is greater than the thickness of plate 30, so as to ensure suitable screwing torque with each screw 26 according to the applicable technical rules without excessively increasing the size of the entire plate 30.

On the connector element whereon there are provided holes 28 (in the example shown, the male element 10) and more precisely, on a side wall of the male element 10, in this example parallel to the axis of screws 26 and of holes 28, there is therefore obtained a slit 34 at each of said holes 28 and in communication therewith, whose function is to allow the insertion, with optional locking into position, of the above plate 30. Slit 34 in fact is provided with a portion or recess 36 enlarged in direction perpendicular to the axis of hole 28 relative to said slit 34, said recess 36 being suitably shaped for the insertion of plate 30 therein. FIG. 1 shows that in the left side from the viewer's side, once plate 30 has been inserted, a riveting 37 is provided which holds the plate inside recess 36, preventing an accidental extraction thereof.

If hole 32 has a larger thickness than that of plate 30, a second enlarged portion 38 may be provided inside slit 34, such enlarged portion 38 being suitably shaped for seating the outer wall of hole 32 and its width being smaller than that of recess 36 for preventing any type of movement of plate 30 in the direction of the longitudinal axis of the screwing action of screw 26.

Similarly to known electrical connectors, on one of the connector elements provided with the fixing system according to the invention there can be further provided one or more teeth 40, in the example built in the sheath of plastic material of the female element 12, which engage in a corresponding projection 42 obtained on the sheath of the opposite element 10. Even if the use of such coupling teeth may be deemed unnecessary in addition to the screw and threaded plate system, in any case they can carry out their function if temporary connections of the component connector elements are required, that is, when it is not necessary to proceed to screwing screws 26 into the corresponding plates 30, but in any case their presence proves that it is not necessary to make any changes to the moulds of the male and female elements of the connector to provide them with the fixing system according to the invention.

Therefore, it has been seen that the fixing system for electrical connectors according to the present invention achieves the objects mentioned hereinbefore, since the introduction of plate 30 having rectangular or square shape in the relevant suitably shaped recess 36 of slit 34 ensure a much higher resistance to rotation, due to the shape itself of plate 30, as compared to common threaded pins of the prior art. Moreover it is virtually impossible to remove plate 30 in the direction of the longitudinal axis of the screwing action, unlike what happens in the solution with pin, due to the presence of recess 36 whose upper portion prevents the extraction in axial direction of plate 30 itself. In any case, several changes and variations can be made to the fixing system for electrical connectors of the present invention thus conceived, all falling within the same inventive concept. So, for example, the position that the recess can take inside the relevant slit is not binding for guaranteeing the mechanical seal of the fixing system, nor are the shape and dimensions that the recess containing the plate can take.

Moreover in the practice, the materials used as well as their sizes and components, can be whatever, according to the technical requirements.

1. Fixing system for an electrical connector intended in particular but not exclusively to be used on printed circuits, said connector comprising:
at least one male element (10) and at least one corresponding female element (12) adapted for being reciprocally connected, said male (10) and female (12) elements being provided with electrical connection means (14; 18a, 18b; 20);
one or more appendages (24), adapted for the insertion of at least one threaded fixing element (26), obtained on the outer sheath of at least one between said male (10) or female (12) elements;
one or more holes (28), adapted for the introduction of the stem of each of said threaded fixing elements (26), obtained on the outer sheath of the other between said male (10) or female elements (12),
characterised in that the threaded portion of each of said fixing elements (26) engages in a threaded hole (32) of at least one plate (30), wherein said hole (32) is arranged in coaxial position relative to said hole (28) and wherein said plate (30) can be arranged, not turnable, in operating position in the other between said male (10) or female (12) elements.

2. Fixing system according to claim 1, characterised in that on the outer sheath of the element (10, 12) on which said one or more holes (28) are provided, there is made at least one slit (34) at each of said holes (28) and in communication therewith, whose function is to allow the insertion as well as the locking of said plate (30) into position.

3. Fixing system according to claim 2, characterised in that said slit (34) is provided with at least one portion or recess (36) enlarged in direction perpendicular to the axis of said hole (28) relative to said slit (34), said recess (36) being provided with an element (37) that holds the plate inside said recess (36), preventing accidental extraction thereof.

4. Fixing system according to claim 1, characterised in that the depth of said threaded hole (32) is greater than the thickness of said plate (30), so as to ensure suitable screwing torque with each of said fixing elements (26) according to the applicable technical rules.

5. Fixing system according to claim 3, characterised in that said slit (34) is provided-with at least a second portion (38) enlarged in direction perpendicular to the axis of said hole (28) relative to said slit (34), said enlarged portion (38) being suitably shaped for seating the outer wall of said hole (32).

6. Fixing system according to claim 4, characterised in that said slit (34) is provided with at least a second portion (38) enlarged in direction perpendicular to the axis of said hole (28) relative to said slit (34), said enlarged portion (38) being suitably shaped for seating the outer wall of said hole (32).

7. Fixing system according to claim 5, characterised in that the width of said second enlarged portion (38) is smaller than the width of said recess (36) for preventing any type of movements of said plate (30) in the direction of the longitudinal axis of the screwing action of said fixing elements (26).

8. Fixing system according to claim 1, characterised in that said plate (30) is manufactured with rectangular or square shape.

9. Fixing system according to claim 8, characterised in that said plate (30) is made of a metal material.

10. Fixing system according to claim 1, characterised in that on the outer sheath of at least one between said male (10) or female elements (12) there are provided one or more teeth (40) that engage in a corresponding projection (42) obtained on the outer sheath of the opposite element between said male (10) or female elements (12).
